(19) United States
(12) Patent Application Publication
(10) Pub. No.: US 2023/0387437 A1
(43) Pub. Date: Nov. 30, 2023

(54) SOLID OXIDE FUEL CELL SYSTEM AND WATER VAPOR GENERATOR AND METHOD OF OPERATION

(71) Applicant: Ceres Intellectual Property Company Limited, Horsham, West Sussex (GB)

(72) Inventor: Weilong Song, Weifang, Shandong (CN)

(21) Appl. No.: 18/029,613

(22) PCT Filed: Oct. 2, 2020
(86) PCT No.: PCT/IB2020/059260

§ 371 Date: Mar. 30, 2023

(51) Int. Cl. H01M 8/0606; H01M 8/1246

(52) U.S. Cl. CPC H01M 8/0606; H01M 8/1246; H01M 2008/1293

(57) ABSTRACT

A solid oxide fuel cell system and a water vapor generator and method of operation. The water vapor generator includes a tank body, a water inlet pipe that can introduce water flow into the tank body, and a heat exchanger located inside the tank body. A water flow can enter the tank body through the water inlet pipe and to exchange heat with the heat exchanger, the heated water forms water vapor. A top portion of the heat exchanger is provided with a recess, the water flow from the water inlet pipe flows into the recess, and the water flow is accumulated in the recess and overflows to exchange heat with the heat exchanger. With this arrangement, if the water flow in the water inlet pipe boils in advance, the recess provided can buffer the impact of the boiling water on the heat exchanger and reduce the pressure fluctuation inside the water vapor generator. Moreover, the water flow evenly flows along an outer peripheral surface of the heat exchanger, and evenly contacts the surface of the heat exchanger, so as to achieve the object of uniform heat exchange between water and the heat exchanger, and reduce the fluctuation in water vapor production and water vapor pressure.

### TECHNICAL FIELD

The present invention relates to the field of fuel cells, in particular to a solid oxide fuel cell system and a water vapor generator and a method of operation.

### BACKGROUND ART

A fuel cell is a highly efficient energy conversion device, which can directly convert the chemical energy of a combustible gas into electrical energy. Because it does not require an intermediate conversion process from mechanical energy to electrical energy, it has higher energy conversion efficiency. A solid oxide fuel cell (SOFC) is a high temperature fuel cell. The operation at a high temperature has broadened its fuel source. An SOFC can use methane, gasoline, diesel and other carbon fuels to generate electricity. In an SOFC system, a carbon fuel first undergoes a water vapor reforming reaction with water vapor at 300 to 800° C., and the hydrogen and carbon monoxide produced by the foregoing water vapor reforming reaction are introduced into an SOFC stack for an electrochemical reaction.

During the process of water vapor reforming reaction, controlling the ratio of carbon fuel to water vapor, improving the dispersion of water vapor and improving the uniformity for mixing water vapor and carbon fuel play are essential to improve system efficiency and increase the durability of an SOFC stack.

The existing fuel and water vapor mixing device for SOFC is a heat exchanger designed based on the principle of boiler. The interior of the water vapor generator is designed to be a plate heat exchanger or a shell-and-tube heat exchanger. Liquid water reaches either the interior or the surface of the heat exchanger through a water inlet device, and then is heated to boiling by a high temperature heat source inside the heat exchanger or by a heating means such as electricity or fuel. So the liquid water becomes water vapor, and the boiling water vapor is next mixed with a carbon fuel and enters a carbon fuel reforming device through a fuel gas outlet for a reforming reaction. However, due to the uncontrollable boiling heat exchange, there are periodic fluctuations in water vapor production and water vapor pressure during the boiling process of liquid water. The periodic fluctuations of water vapor production and pressure have a negative effect on the uniformity of subsequent mixing between the fuel and water vapor, the continuity of the water vapor reforming reaction, and the continuity of the electrochemical reaction in the reactor.

### SUMMARY OF THE INVENTION

A first aspect of the invention provides a water vapor generator for a solid oxide fuel cell system, the water vapor generator comprising a tank body, a water inlet pipe that can introduce water into the tank body, and a heat exchanger arranged inside the tank body; a water flow enters the tank body through the water inlet pipe to exchange heat with the heat exchanger so as to form water vapor, a top portion of the heat exchanger is provided with a recess, a water flow from the water inlet pipe flows into the recess, and the water flow is accumulated in the recess and then overflows therefrom to exchange heat with the heat exchanger.

The recess projects downwadly from a peripheral edge of the top portion of the heat exchanger toward a middle portion thereof.

The recess is can be an arc shape.

An end of the water inlet pipe can be provided with a distributed dripper to make the water flow evenly enter the recess. The distributed dripper can comprise a plurality of drippers connected in parallel and distributed centrosymmetrically at equal intervals.

The heat exchanger can be a plate heat exchanger, and a surface of the plate heat exchanger can be provided with fins.

The water inlet pipe can be provided with a regulating valve and/or a pressure sensor, the regulating valve regulates the flow of water from the water inlet pipe into the tank body, and the pressure sensor detects the pressure at the water inlet pipe.

The tank body can be provided with a water vapor outlet for water vapor to exit therefrom.

The water vapor outlet can be provided with a pressure sensor and/or a temperature sensor. The pressure sensor detects the pressure of the water vapor discharged from the water vapor outlet, and the temperature sensor detects the temperature of the water vapor discharged from the water vapor outlet.

The water vapor generator can be provided with an inlet in communication with the heat exchanger. The inlet is configured to introduce a high-temperature gas, and the inlet is provided with a regulating valve for regulating the flow of an incoming high-temperature gas.

A second aspect of the invention provides a solid oxide fuel cell system, which comprises a burner which burns to generate hot air of high temperature, and further comprises the water vapor generator according to any one of the above descriptions; the water vapor generator is provided with the inlet and an outlet in communication with a heat exchanger, and the hot air of high temperature enters the heat exchanger via the inlet and exits via outlet.

A third aspect of the invention provides a method of operating the water vapor generator.

For the solid oxide fuel cell system and its water vapor generator provided by the present invention, a recess is provided in a top portion of the heat exchanger. Water flows into the recess from an end of the water inlet pipe and accumulates in the recess. After the recess is fully filled with water, the water in the recess overflows from the outer edge of the recess, and the overflowing water then flows down evenly along the periphery of the heat exchanger. With this arrangement, if the water flow in the water inlet pipe boils in advance, the recess provided can buffer the impact of the boiling water on the heat exchanger and reduce the pressure fluctuation inside the water vapor generator. Moreover, the water flow evenly flows along an outer peripheral surface of the heat exchanger, and evenly contacts the surface of the heat exchanger, so as to achieve the object of uniform heat exchange between water and the heat exchanger, and reduce the fluctuation in water vapor production and water vapor pressure. It can be seen that this setting is beneficial to the uniformity of subsequent mixing of the fuel and water vapor, the continuity of the water vapor reforming reaction, and the continuity of the electrochemical reaction in the stack.

### BRIEF DESCRIPTION OF DRAWINGS

FIG. 1 is a schematic structural diagram of a specific embodiment of a water vapor generator for a solid oxide fuel cell system.

FIG. 2 is a schematic structural diagram showing the cooperation between the distributed dripper of the water vapor generator in FIG. 1 and the recess in the top portion of the heat exchanger.

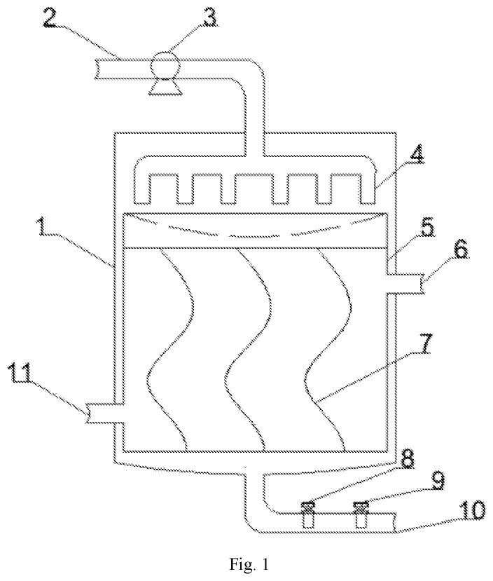

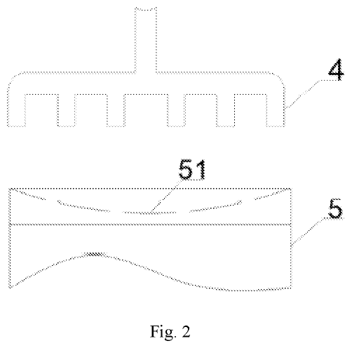

The reference signs in FIGS. 1 and 2 are as follows:

1 tank body, 2 water inlet pipe, 3 regulating valve, 4 distributed dripper, 5 heat exchanger, 51 recess, 6 inlet, 7 fin, 8 temperature sensor, 9 pressure sensor, 10 water vapor outlet, 11 outlet.

### DESCRIPTION OF THE EMBODIMENTS

Embodiments of the present invention will be further described in detail with reference to the accompanying drawings.

The water vapor generator for a solid oxide fuel cell system provided by the this embodiment includes a tank body 1, a water inlet pipe 2 that can introduce water into the tank body 1, and a heat exchanger 5 located inside the tank body 1. The tank body 1 is provided with a water vapor outlet 10. After the water from the water inlet pipe 2 enters the tank body 1, it contacts the heat exchanger 5 in the tank body 1 to exchange heat. The water absorbs the heat of the heat exchanger 5 to evaporate into water vapor. Then the water vapor is discharged from the water vapor outlet 10 and enters a next device for the subsequent reaction. As shown in FIG. 1, the water inlet pipe 2 is located directly above the tank body 1, an end of the water inlet pipe 2 is directly opposite to the top portion of the heat exchanger 5, and the water vapor outlet 10 can be arranged directly below the tank body 1.

Moreover, in this embodiment, a recess 51 is provided in a top portion of the heat exchanger 5. Water flows into the recess 51 from an end of the water inlet pipe 2 and accumulates in the recess 51. After the recess 51 is fully filled with water, the water in the recess 51 overflows from the outer edge of the recess 51, and the overflowing water then flows down evenly along the periphery of the heat exchanger 5. With this arrangement, if the water flow in the water inlet pipe 2 boils in advance, the recess 51 provided can buffer the impact of the boiling water on the heat exchanger 5 and reduce the pressure fluctuation inside the water vapor generator. In addition, the water flow evenly flows along an outer peripheral surface of the heat exchanger 5, and evenly contacts the surface of the heat exchanger 5, so as to achieve the object of uniform heat exchange between water and the heat exchanger 5, and reduce the fluctuation in water vapor production and water vapor pressure. It can be seen that this setting is beneficial to the uniformity of subsequent mixing of the fuel and water vapor, the continuity of the water vapor reforming reaction, and the continuity of the electrochemical reaction in the stack.

In order to further ensure that the water overflowing from the recess 51 can flow downward from the outer periphery of the heat exchanger 4 more evenly, the recess 51 may depress from the peripheral edge of the top portion of the heat exchanger 5 toward the middle portion thereof.

Specifically, the recess 51 may be a recess in an arc shape. As shown in FIG. 1, the cross section of the recess 51 is in an arc shape, and the entire depressing surface of the recess 51 is in an arc shape. The middle position in the top portion of the heat exchanger 5 is the deepest position. The curved recess makes the water flow smoother and overflow more evenly. As shown in FIG. 2, the axis of the heat exchanger 5 and the axis of the tank body 1 may overlap. In this way, the uniformity of water overflow on both sides can be more easily ensured. The recess 51 is an arc shaped recess, and the arc can reach 180 degrees, which is equivalent to setting a half-cylinder recess 51. The diameter of the recess 51 can be selected from 8 to 12 mm, for example, 10 mm. The recess 51 may also be a recess in another shape, as long as it can be ensured that water can accumulate in the recess 51 and the water stored in the pit recess can overflow from the outer edge of the recess 51 and evenly flow down from the peripheral surface of the heat exchanger 5. For example, the recess 51 may be a trapezoidal recess or a recess in the shape of a truncated cone. Alternatively, the recess 51 can be a non-circular arc, such as an arc of an ellipse, a parabola, or a hyperbola.

An end of the water inlet pipe 2 is provided with a distributed dripper 4. The distributed dripper 4 includes a plurality of parallel drippers, and the plurality of drippers is distributed centrosymmetrically at equal intervals at the end of the water inlet pipe 2. In addition, the distributed dripper 4 is located directly above the recess 51. The distributed dripper 4 can evenly disperse the water flow from the water inlet pipe 2 into the recess 51 to ensure that the water flow first evenly flows to the recess 51, and then evenly overflows from the recess 51, thereby ensuring even heat exchange between the water flow and the heat exchanger 5.

The design size of the distributed dripper 4 is preferably matched to the recess 51, that is, the spacing distance and the number of the drippers may be designed according to the size of the recess 51 so as to ensure that the water droplets from the distributed dripper 4 can evenly fall into the recess 51 and then overflow therefrom. In this way, the uniformity of heat exchange between the heat exchanger 5 and the water flow can be ensured. For example, for the recess 51 of the above-mentioned size, the number of drippers can be set to 6, and the spacing distance between drippers can be from 1 to 3 mm, where 2 mm can be selected.

The heat exchanger 5 may specifically be a plate heat exchanger, and the surface of the plate heat exchanger is provided with fins 7 to increase the heat exchange contact area, so as to ensure sufficient heat exchange. In this embodiment, the width of the fin 7 can be from 5 to 10 mm, such as 6 mm. The water overflows from the recess 51 and then flows down evenly along the outer peripheral surface of the heat exchanger 5. During this process, the water contacts the surface of the heat exchanger 5 and the fins 7, absorbs the heat from the surface of the heat exchanger 5 and the fins 7, and then evaporates into water vapor. Subsequently, the water vapor generated by evaporation is discharged from the water vapor outlet 10 at the bottom of the tank body 1 and then enters a next device to participate in the following reaction. Similarly, other types of heat exchangers can also be used; for example, a shell-and-tube heat exchanger can be used.

In addition, in this embodiment, the water inlet pipe 2 may also be provided with a regulating valve 3 arranged on the outer side of the tank body 1, which is used to regulate the flow of water from the water inlet pipe 2 to enter the tank body 1. A pressure sensor for detecting the pressure at the water inlet pipe 2 may also be provided. Moreover, a regulating valve may be provided in the pipeline for introducing a high-temperature gas to the heat exchanger 5, in order to adjust the flow rate of the high-temperature gas introduced. The water vapor outlet pipeline connected to the water vapor outlet 10 is provided with a pressure sensor 8 and a temperature sensor 9, which are also arranged on the outer side of the tank body 1. The pressure sensor 8 and the temperature sensor 9 can monitor the pressure and temperature of the water vapor discharged from the water vapor outlet 10 and an inlet for high-temperature air. When the water vapor generated by the water vapor generator is discharged from the water vapor outlet 10, the pressure sensor 8 and the temperature sensor 9 on the pipeline connected to the water vapor outlet 10 detect the pressure and temperature of the discharged water vapor. According to the detection values of the pressure sensor 8 and the temperature sensor 9, the regulating valve 3 of the water inlet pipe 2 can be adjusted, thereby adjusting the water inlet flow of the water inlet pipe 2.

The temperature of the working environment of the water vapor generator is relatively high (about 100° C. to 200° C.). As a result, the water in the water inlet pipe 2 may undergo heat exchange with the external environment before it flows out of the water inlet pipe 2 and enters the tank body 1, so that premature boiling may occur. In this solution of the present invention, by controlling the flow rate of the water inlet pipe 2, the water flow in the water inlet pipe 2 can be prevented from prematurely boiling, and the water flow rate can also meet the actual requirements. Since the water does not boil in advance, the pressure fluctuation at the water vapor outlet 10 is minimized. In this way, there is little impact on the uniformity of subsequent mixing of the fuel with water vapor, the continuity of the water vapor reforming reaction, and the continuity of the electrochemical reaction in the stack, thereby ensuring the efficiency of the solid oxide fuel cell system.

When the temperature detected by the temperature sensor 9 exceeds 600° C., the regulating valve into which the high-temperature gas enters can be closed to avoid damage to the water vapor generator caused by an excessively high temperature. When the value detected by the pressure sensor 8 at the water vapor outlet 10 exceeds 300 mbar, the regulating valve 3 at the water inlet pipe 2 and the regulating valve at the high-temperature gas inlet can be closed at the same time to avoid damage to the water vapor generator caused by excessively high pressure. According to the detection value of the pressure sensor at the water inlet pipe 2 and the pressure sensor 8 at the water vapor outlet 10, the pressure drop can be obtained. When the pressure drop is greater than 6 mbar, the opening degree of the regulating valve 3 at the water inlet pipe 2 may be controlled to adjust the water inlet volume so that the pressure drop can meet the design requirements. In general, the pressure fluctuation is required to be stable at about 4 mbar, and the maximum value cannot exceed 16 mbar. All of the above-mentioned regulating valves can be electric regulating valves for easy control.

Furthermore, in this embodiment, a burner may be further provided for the solid oxide fuel cell system, and the burner burns to generate high-temperature hot air. The water vapor generator is provided with an inlet 6 and an outlet 11 in communication with the heat exchanger 5. The inlet 6 is the inlet in communication with the high-temperature gas pipeline mentioned above. The high-temperature hot air generated by the burner can enter the heat exchanger 5 via the inlet 6 to work as the hot fluid of the heat exchanger 5, which can transfer the heat to the shell and the fins 7 of the heat exchanger 5. After the heat exchange is completed, it can be discharged from the heat exchanger 5 via the outlet 11. That is, the burner of the solid oxide fuel cell system can provide the high-temperature gas required by the water vapor generator without additional heating equipment.

The above are only some embodiments of the present invention. Without departing from the principles of the present invention, certain improvements and modifications can be made. These improvements and modifications should also be regarded as within the scope of protection of the present invention.

1. A water vapor generator for a solid oxide fuel cell system, comprising:
a tank body,
a water inlet pipe for introducing water into the tank body, and
a heat exchanger arranged inside the tank body;
wherein a water flow can enter the tank body through the water inlet pipe to exchange heat with the heat exchanger so as to form water vapor;
wherein the water vapor generator is characterized in that a top portion of the heat exchanger is provided with a recess such that a water flow from the water inlet pipe can flow into the recess, be accumulated in the recess, and then overflow therefrom to exchange heat with the heat exchanger.

2. The water vapor generator according to claim 1, wherein the recess extends downwardly from a peripheral edge of the top portion of the heat exchanger toward a middle portion thereof.

3. The water vapor generator according to claim 1, wherein the recess is in an arc shape.

4. The water vapor generator according to claim 1, wherein an end of the water inlet pipe is provided with a distributed dripper to cause the water to flow evenly into the recess;
wherein the distributed dripper comprises a plurality of drippers connected in parallel, and the plurality of drippers are distributed centrosymmetrically at equal intervals.

5. The water vapor generator according to claim 1, wherein the heat exchanger is a plate heat exchanger, and a surface of the plate heat exchanger is provided with fins.

6. The water vapor generator according to claim 1, wherein the water inlet pipe is provided with at least one of a regulating valve and a pressure sensor, the regulating valve being configured to regulate the flow of water from the water inlet pipe into the tank body, and the pressure sensor being configured to detect the pressure at the water inlet pipe.

7. The water vapor generator according to claim 1, wherein the tank body is provided with a water vapor outlet for water vapor to exit therefrom, and the water vapor outlet is provided with at least one of a pressure sensor and a temperature sensor,
wherein the pressure sensor is configured to detect the pressure of the water vapor discharged from the water vapor outlet, and the temperature sensor is configured to detect the temperature of the water vapor discharged from the water vapor outlet.

8. The water vapor generator according to claim 1, wherein the water vapor generator is provided with an inlet in communication with the heat exchanger, wherein the inlet is configured to introduce a high-temperature gas, and the inlet is provided with a regulating valve for regulating the flow of an incoming high-temperature gas.

9. The water vapor generator according to claim 3, wherein the recess is a non-circular arc comprising an arc of an ellipse, a parabola, or a hyperbola.

10. A solid oxide fuel cell system, comprising a burner which burns to generate high temperature hot and a water vapor generator according to claim 1; wherein the water vapor generator is provided with an inlet and an outlet in communication with a heat exchanger, such that the high temperature hot air enters the heat exchanger via the inlet and exits via outlet.

11. A method of operating a water vapor generator according to claim 1, wherein the method comprises:
introducing a water flow from the water inlet pipe into the recess, allowing water to accumulated in the recess, and allowing water to overflow therefrom to exchange heat with the heat exchanger.

12. The method according to claim 11, comprising:
measuring the temperature of the water vapor at the outlet; and
preventing the flow of high temperature gas into the heat exchanger when the measured temperature exceeds a predetermined level.

13. The method according to claim 11, comprising:
measuring the pressure of the water vapor at the outlet; and
preventing the flow of water and high temperature gas into the heat exchanger when the measured pressure exceeds a predetermined level.

14. The method according to claim 11, comprising:
measuring the pressure drop between the water inlet and the water outlet; and
controlling the water inlet to maintain the pressure drop within a predetermined range.
